(19) United States
(12) Patent Application Publication
(10) Pub. No.: US 2018/0275549 A1
(43) Pub. Date: Sep. 27, 2018

(54) LIQUID DEVELOPER AND LIQUID DEVELOPER CARTRIDGE

(71) Applicant: FUJI XEROX CO., LTD., Tokyo (JP)

(72) Inventors: Kazusei YOSHIDA, Kanagawa (JP); Daisuke YOSHINO, Kanagawa (JP); Masahiro OKI, Kanagawa (JP); Akira IMAI, Kanagawa (JP); Yoshitake OGURA, Kanagawa (JP); Takako KOBAYASHI, Kanagawa (JP); Koji HORIBA, Kanagawa (JP); Manabu KAWASHIMA, Kanagawa (JP); Fumiaki MERA, Kanagawa (JP); Tetsuya TAGUCHI, Kanagawa (JP)

(73) Assignee: FUJI XEROX CO., LTD., Tokyo (JP)

(21) Appl. No.: 15/830,759

(22) Filed: Dec. 4, 2017

(30) Foreign Application Priority Data
Mar. 21, 2017 (JP) 2017-054607

(51) Int. Cl. G03G 9/13; G03G 9/12; G03G 9/125; G03G 9/135

(52) U.S. Cl. CPC G03G 9/132; G03G 9/1355; G03G 9/125; G03G 9/122

(57) ABSTRACT

A liquid developer includes toner particles containing, as a binder resin, at least a polyester resin containing a monomer unit, which includes a linear or branched chain saturated hydrocarbon chain having 2 to 5 carbon atoms between ester bonds, in a range of from 5 mol % to 25 mol % with respect to all monomer units included in the polyester resin, and a colorant; and a carrier liquid including an insulating liquid.

### CROSS-REFERENCE TO RELATED APPLICATIONS

This application is based on and claims priority under 35 USC 119 from Japanese Patent Application No. 2017-054607 filed Mar. 21, 2017.

### BACKGROUND

### 1. Technical Field

The present invention relates to a liquid developer and a liquid developer cartridge.

### 2. Related Art

As a developer useful for image formation according to electrophotographic system, a liquid developer in which toner particles are dispersed in a carrier liquid is known.

### SUMMARY

According to an aspect of the invention, there is provided a liquid developer including:

toner particles containing, as a binder resin, at least a polyester resin containing a monomer unit which includes a linear or branched chain saturated hydrocarbon chain having 2 to 5 carbon atoms between ester bonds, in a range of from 5 mol % to 25 mol % with respect to all monomer units of the polyester resin, and a colorant; and

carrier liquid including an insulating liquid.

### BRIEF DESCRIPTION OF THE DRAWING

Exemplary embodiments of the present invention will be described in detail based on the following FIGURE, wherein:

FIG. 1 is a schematic configuration diagram showing an example of an image forming apparatus according to the exemplary embodiment.

### DETAILED DESCRIPTION

Description will be given below of exemplary embodiments of the present invention. These descriptions and examples are illustrative of exemplary embodiments and do not limit the scope of the invention.

In the present disclosure, in a case of referring to the amount of each component, in the composition, in a case where there are plural types of substances corresponding to each component in the composition, the amount means the total amount of the plural substances present in the composition unless otherwise specified.

In the present disclosure, the meaning of “(meth)acrylic” includes both “acrylic” and “methacrylic”,

In the present disclosure, the “monomer unit.” of the polyester resin means a constituent unit obtained by polycondensation of a monomer. In the present disclosure, the number of carbon atoms in the saturated hydrocarbon chain between ester bonds in the monomer unit of the polyester resin is the number of carbon atoms present, in the saturated hydrocarbon chain (carbon atom included in the ester bond (—COO—) is excluded).

### <Liquid Developer>

The liquid developer according to the exemplary embodiment includes toner particles containing a polyester resin containing a monomer unit which includes a linear or branched chain saturated hydrocarbon chain having 2 to 5 carbon atoms between ester bonds, in a range of from 5 mol % to 25 mol % with respect to all the monomer units of the polyester resin, and a colorant; and a carrier liquid.

Hereinafter, the polyester resin containing a monomer unit which includes a linear or branched, chain saturated hydrocarbon chain having 2 to 5 carbon atoms between ester bonds in a range of from 5 mol % to 25 mol % with respect to all the monomer units of the polyester resin is referred to as the “specific polyester resin”, and the monomer unit which includes a linear or branched chain saturated hydrocarbon chain having 2 to 5 carbon atoms between ester bonds is referred to as the “specific monomer unit”.

The liquid developer according to the exemplary embodiment forms an image excellent in graininess. As this mechanism, the following is presumed.

Colorants generally have a low affinity for the carrier liquid included in the liquid developer. Therefore, in the case where the number of the colorant exposed on the surface of the toner particles by the colorant is larger, the toner particles become more susceptible to the influence of the colorant and are more likely to aggregate in the carrier liquid, and therefore, the image tends to be deteriorated in graininess.

On the other hand, it is presumed that the specific polyester resin containing the specific monomer unit in an amount of 5 mol % or more with respect to all the monomer units improves the affinity for the colorant and, in the process of preparing the toner particles, it is easy to incorporate the colorant into the specific polyester resin and the colorant is prevented from being exposed on the surface of the toner particles. Therefore, it is presumed that the number of the colorant exposed on the surface of the toner particles containing the specific polyester resin is relatively small and the formation of aggregation of the toner particles in the carrier liquid is prevented and therefore, the graininess of the image is excellent. From, this viewpoint, the content of the specific monomer unit in the specific polyester resin is 5 mol % or more, preferably 10 mol % or more, and more preferably 15 mol % or more.

On the other hand, the specific monomer unit is considered to have a lower affinity for the carrier liquid than other monomer units, and when present in excess, aggregation of the toner particles may occur. Accordingly, the content of the specific monomer unit is 25 mol % or less in the specific polyester resin. From this viewpoint, the content of the specific monomer unit, in the specific polyester resin is 25 mol % or less, more preferably 20 mol % or less, and even more preferably 18 mol % or less.

A description will be given below of the components of the liquid developer according to the exemplary embodiment,

### [Toner Particles]

The toner particle contains at least a specific polyester resin and a colorant, and may further contain a release agent and other additives. An external additive (for example, inorganic particles) maybe attached to the surface of the toner particle.

### —Specific Polyester Resin—

The toner particles contain the specific polyester resin as a binder resin. Examples of the specific polyester resin include a condensation polymer of a polyvalent carboxylic acid and a polyol.

The specific polyester resin contains a specific monomer unit in a range of from 5 mol % to 25 mol % with respect, to all the monomer units. The specific monomer unit is a monomer unit formed of only a linear or branched chain saturated hydrocarbon chain having from 2 to 5 carbon atoms between ester bonds. The specific monomer unit may be a monomer unit derived from a polyvalent, carboxylic acid or may be a monomer unit derived from a polyol, and a unit derived from a polyvalent carboxylic acid and a unit derived from a polyol may be used in combination, with the total content of the units being in a range of from 5 mol % to 25 mol %. The specific monomer unit is preferably a monomer unit derived from a dicarboxylic acid or a monomer unit derived from a diol.

As the polyvalent carboxylic acid for forming the specific monomer unit, a dicarboxylic acid formed of a linear or branched chain saturated hydrocarbon chain having 2 to 5 carbon atoms between two carboxy groups is preferable. The number of carbon atoms in the saturated hydrocarbon chain of the polyvalent carboxylic acid is the number of carbon atoms excluding a carbon atom included in each carboxy group. Examples of the polyvalent carboxylic acid for forming the specific monomer unit, include methylmalonic acid (having 2 carbon atoms in the saturated hydrocarbon chain, branched chain), succinic acid (2 carbon atoms, linear chain), methylsuccinic acid (3 carbon atoms, branched chain), glutaric acid (3 carbon atoms, linear chain), 3-methylglutaric acid (4 carbon atoms, branched chain), adipic acid (4 carbon atoms, linear chain), 3-methyladipic acid (5 carbon atoms, branched chain), 2-ethylglutaric acid (5 carbon atoms, branched chain), pimelic acid (5 carbon atoms, linear chain), and the like. One of these polyvalent carboxylic acids may be used alone or two or more types thereof may be used in combination.

Examples of other polyvalent carboxylic acids for forming the specific polyester resin include suberic acid, sebacic acid, dodecanedioic acid, oxalic acid, malonic acid, maleic acid, fumaric acid, citraconic acid, glutaconic acid, alicyclic dicarboxylic acid (for example, cyclohexane dicarboxylic acid, and the like), aromatic dicarboxylic acids (for example, terephthalic acid, isophthalic acid, phthalic acid, naphthalene dicarboxylic acid, and the like), trimellitic acid, pyromellitic acid, anhydrides thereof, or lower (for example, having from 1 to 5 carbon atoms) alkyl esters, and an aromatic dicarboxylic acid is preferable. One of these polyvalent carboxylic acids may be used alone or two or more types thereof may be used in combination.

As the polyol for forming the specific monomer unit, a diol formed of a linear or branched chain saturated hydrocarbon chain having from 2 to 5 carbon atoms between two hydroxy groups is preferable. Examples of polyols forming the specific monomer unit include ethylene glycol (having 2 carbon atoms in the saturated hydrocarbon chain, linear chain), 1,3-propanediol (3 carbon atoms, linear chain), propylene glycol (also known as 1,2-propanediol, 3 carbon atoms, branched chain), 1,4-butanediol (4 carbon atoms, linear chain), 1,2-butanediol (4 carbon atoms, branched chain), 1,5-pentanediol (5 carbon atoms, linear chain), 1,2-pentanediol (5 carbon atoms, branched chain), neopentyl glycol (5 carbon atoms, branched chain), and the like. One of these polyols may be used alone or two or more types thereof may be used in combination.

Examples of other polyols forming the specific, polyester resin include 1,6-hexanediol, 1,2-hexanediol, alicyclicdiols (for example, cyclohexanediol, cyclohexanedimethanol, hydrogenated bisphenol A, and the like), diethylene glycol, triethylene glycol, aromatic diols (for example, bisphenol A, a bisphenol A ethylene oxide adduct, a bisphenol A propylene oxide adduct, and trie like), and glycerin, and aromatic diols are preferable. One of these polyols may be used alone or two or more types thereof may be used in combination.

From the viewpoint of affinity for a carrier liquid, the specific polyester resin preferably contains a monomer unit having an aromatic, ring. The content of the monomer unit having an aromatic ring in the specific polyester resin is preferably in the range of from 50 mol % to 95 mol % with respect to all the monomer units, more preferably from 55 mol % to 85 mol %, and more preferably in the range of from 60 mol % to 75 mol %.

The aromatic ring in the monomer unit having an aromatic ring is preferably a benzene ring, a naphthalene ring, or an anthracene ring, more preferably a benzene ring or a naphthalene ring, and even more preferably a benzene ring. The number of aromatic rings in the monomer unit having an aromatic ring is not limited, but is preferably from 1 to 4, more preferably from 1 to 3, and even more preferably 1 or 2. The monomer unit having an aromatic ring may be a monomer unit derived from a polyvalent carboxylic acid or may be a monomer unit derived from a polyol, and the total of the derived polyvalent carboxylic acid and the derived polyol may be in the above range. The monomer unit having an aromatic ring is preferably a monomer unit derived from a dicarboxylic acid or a monomer unit derived from, a diol.

Examples of the polyvalent carboxylic acid for forming the monomer unit having an aromatic ring include terephthalic acid, isophthalic acid, phthalic acid, and aromatic dicarboxylic acids such as 2,6-naphthalenedicarboxylic acid, 1,4-naphthalenedicarboxylic acid, and 2,3-naphthalenedicarboxylic acid.

Examples of the polyol for forming the monomer unit having an aromatic ring include aromatic diols such as bisphenols such as bisphenol A, bisphenol AP, bisphenol B, bisphenol BP, bisphenol C, bisphenol E, and bisphenol F, ethylene oxide adducts of these bisphenols, and propylene oxide adducts of these bisphenols.

The weight average molecular weight (Mw) of the specific polyester resin is preferably from 5,000 to 1,000,000, more preferably from 7,000 to 500,000, even more preferably from 8,000 to 30,000, and even more preferably from 8,000 to 20,000. The number average molecular weight (Mn) of the specific polyester resin is preferably from 2,000 to 100,000. The molecular weight distribution Mw/Mn of the specific polyester resin is preferably from 1.5 to 100, and more preferably from 2 to 60.

The toner particles may include other binder resins than the specific polyester resin. However, the ratio of the content of the specific polyester resin to the total content of the binder resin included in the toner particle is preferably 50% by weight or more, more preferably 80% by weight or more, even more preferably 90% by weight or more, and even more preferably 95% by weight or more, the binder resin included in the toner particles is particularly preferably substantially only the specific polyester resin.

Examples of binder resins other than the specific polyester resin include vinyl resins formed of homopolymers of monomers such as styrenes (for example, styrene, parachlorostyrene, α-methylstyrene, and the like), (meth) acrylate esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenic unsaturated nitrites (for example, aerylonitrile, methacrylonitrile, and the like), vinyl ethers (for example, vinyl methyl ether, vinyl isobutyl ether, and the like), vinyl ketones (vinyl methyl ketone, vinyl ethyl ketone, vinyl isopropenyl ketone, and the like), olefins (for example, ethylene, propylene, butadiene, and the like) or copolymers combining two or more of these monomers; non-vinyl resins such as epoxy resins, polyurethane resins, polyamide resins, cellulose resins, polyether resins, and modified rosins, mixtures of the above with vinyl resins, and graft polymers obtained by polymerizing vinyl monomers in the presence thereof. One of these binder resins may be used alone or two or more types thereof may be used in combination.

In the toner particles in the exemplary embodiment, the total content of the binder resin is preferably from 40% by weight to 95% by weight with respect to the total amount of the toner particle, more preferably from 50% by weight to 90% by weight, and even more preferably from 60% by weight to 85% by weight.

### —Colorant—

Examples of the colorant include pigments such as carbon black, chrome yellow, Hansa yellow, benzidine yellow, threne yellow, quinoline yellow, pigment, yellow, permanent orange GTR, pyrazolone orange, vulcan orange, Wacht-Young Red, permanent red, Brilliant Carmine 3B, Brilliant Carmine 6B, Du Pont oil red, pyrazolone red, lysol red, rhodamine B lake, lake red C, pigment red. Rose Bengal, aniline blue, ultramarine blue, calco oil blue, methylene blue chloride, phthalocyanine blue, Pigment Blue, phthalocyanine green, malachite green oxalate, and the like; acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, thiazole dyes, and the like. One of these colorants may be used alone or two or more types thereof may be used in combination.

In these colorants, azo pigments have a relatively low affinity for the carrier liquid. Accordingly, the toner particles containing the azo pigment, are likely to aggregate in the carrier liquid in a case where the azo pigments are exposed on the surface, and therefore, the graininess of the image is poor. The exemplary embodiment prevents aggregation of the toner particles even in toner particles using the azo pigments as a colorant, and the graininess of the image is excellent.

Examples of the azo pigment include C.I. Pigment Red 238, 269, 57:1, and 184; C.I. Pigment Yellow 74, 155, and 180; and the like.

As the colorant, a surface-treated colorant may be used if necessary, and the colorant may be used in combination with a dispersant. In addition, plural colorants may be used in combination.

The content of the colorant is, for example, preferably from 1% by weight, to 30% by weight with respect to a total amount of the toner particle, more preferably from 1% by weight to 20% by weight, and even more preferably from 3% by weight to 15% by weight,

### —Release Agent—

Examples of the release agent include low molecular weight polyolefins such as polyethylene, polypropylene, and polybutene; silicones; fatty acid amides such as oleic acid amide, erucic acid amide, ricinoleic acid amide, and stearic acid amide; plant waxes such as carnauba wax, rice wax, candelilla wax, wood wax, and jojoba oil; animal waxes such as beeswax; mineral waxes such as montan wax, ozokerite, ceresin, paraffin wax, microcrystalline wax, and Fischer-Tropsch wax; petroleum waxes; and the like. One of these release agents may be used alone or two or more types thereof may be used in combination.

The melting temperature of the release agent is preferably from 50° C. to 110° C., and more preferably from 60° C. to 100° C. The melting temperature of the release agent is determined from a DSC curve obtained by differential scanning calorimetry (DSC) according to “Melting Peak Temperature” described in the method for determining a melting temperature in “Testing Methods for Transition Temperatures of Plastics” in JIS K7121; 1387.

The content of the release agent is, for example, preferably from 0.5% by weight to 50% by weight with respect to all of the toner particles, more preferably from 1% by weight to 30% by weight, even more preferably from 1% by weight to 20% by weight, and still more preferably from 5% by weight to 15% by weight.

### —Other Additives—

Examples of other additives include known additives such as magnets, charge-controlling agents, inorganic powder, and the like. These additives are included in toner particles as internal additives.

### [Carrier Liquid]

The carrier liquid includes at least an insulating liquid and may further include a dispersant, a charge-controlling agent, and the like.

### —Insulating Liquid—

The insulating liquid is an insulating liquid for dispersing toner particles. In the exemplary embodiment, the “insulating” preferably means insulating properties with an electrical conductivity of 1×10⁻¹⁰ S/m or less.

The insulating liquid may be either a non-volatile oil or a volatile oil, but a volatile oil is preferable. In a case where the insulating liquid includes a volatile oil, the concentration of the toner particles increases clue to the volatilization of the volatile oil in the liquid developer and the toner particles easily aggregate; however, in the exemplary embodiment, aggregation of the toner particles is prevented.

In the exemplary embodiment, the volatile oil means an oil having a flash point of 130° C. or less, or an oil having a volatilization amount of 8% by weight or more when kept to stand at 150° C. for 24 hours. The flash point is the temperature measured according to JIS K 2265-4: 2 007.

The carrier liquid preferably has a flash point of 130° C. or less.

Examples of the insulating liquid include mineral oils (aliphatic hydrocarbons and aromatic hydrocarbons); silicone oils such as dimethyl silicone oil, methyl hydrogen silicone oil, and methyl phenyl silicone oil; polyol compounds such as ethylene glycol, diethylene glycol, and propylene glycol; fatty acid esters such as methyl oleate, ethyl oleate, and methyl linoleate; and the like. One of these insulating liquids may be used alone or two or more types thereof may be used in combination.

The insulating liquid is preferably a mineral oil from the viewpoint of dispersion stability of toner particles. Mineral oils include not only hydrocarbons derived from underground resources such as petroleum, natural gas, and coal, but also hydrocarbons derived from underground resources and purified, denatured, or the like. Examples of the mineral oil include aliphatic hydrocarbons such as isoparaffin, normal paraffin, naphthene, and olefin; and aromatic hydrocarbons such as benzene, toluene, xylene, mesitylene, and the like. One of these insulating liquids may be used alone or two or more types thereof may be used in combination. As the mineral oil, an aliphatic hydrocarbon is preferable, paraffin is more preferable, and isoparaffin is even more preferable.

The ratio of the content of the mineral oil in the insulating liquid is preferably 50% by weight or more, more preferably 80% by weight or more, even more preferably 90% by weight or more, and still more preferably 95% by weight or more, and the insulating liquid is particularly preferably substantially only mineral oil.

Examples of commercially available mineral oil products include “ISOPAR L” (isoparaffin), “ISOPAR M” (isoparaffin), “EXXOL D80” (naphthene), “EXXOL DUO” (naphthene), “SQLVESSO 100” (aromatic hydrocarbons), and “SOLVESSO 150” (aromatic hydrocarbons) from Exxon Mobil Corporation; “MORESCO WHITE P-40” (paraffin), “MORESCO WHITE P-70” (paraffin), “MORESCO WHITE P-80” (paraffin), “MORESCO WHITE P-100” (paraffin), and “MORESCO WHITE P-200” (paraffin) from Moresco Corporation; NAPHTESOL 200 (naphthene), and NAPHTESOL 220 (naphthene) from JXTG Nippon Oil & Energy Corporation; and the like.

### —Dispersant—

The dispersant is not particularly limited, and known dispersants (low molecular dispersants and polymer dispersants) are used. As the dispersant, a polymer dispersant is preferable from the viewpoint of dispersion stability of toner particles. One of these dispersants may be used alone or two or more types thereof may be used in combination.

From the viewpoint of the dispersion stability of the toner particles, the polymer dispersant is preferably a polymer amine compound having an affinity for the acidic group of the polyester resin present on the surface of the toner particle. The polymer amine compound may be also used as a positively chargeable charge-controlling agent.

Examples of the polymer amine compound include a compound having at least one selected from a polyalkyleneimine chain (a polyethyleneimine chain, a polypropylene inline chain, and the like), a polyallylamine chain, a polyvinylamine chain, a polydiallylamine chain, and a polyvinylpyrrolidone chain in the molecule.

As the polymer amine compound, a compound having at least one of a polyethyleneimine chain and a polyallylamine chain in the molecule is preferable.

Examples of the compound having a polyethyleneimine chain in the molecule include a reaction product of polyethyleneimine and a 12-hydroxystearic acid self-condensation product (for example, SOLSPERSE 13940, Lubrizol Corporation), and the like.

Examples of the compound having a polyallylamine chain in the molecule include a reaction product of polyallylamine and polycaprolactone (for example, AJISPER PB 821, Ajinomoto Fine-Techno Co., Inc.), and the like.

From the viewpoint of dispersion stability of the toner particles, the weight average molecular weight of the polymer dispersant is preferably from 100 to 1,000,000, and more preferably from 1,000 to 100,000.

From the viewpoint of dispersion stability and chargeability of the toner particles, the content of the polymer dispersant is preferably from 0.01 parts by weight to 100 parts by weight with respect to 100 parts by weight of the toner particles, and more preferably from 0.1 part by weight to 10 parts by weight.

### —Charge-Controlling Agent—

The charge-controlling agent is not particularly limited, and a known charge-controlling agent is used. Examples of the charge-controlling agent include nigrosine dyes such as unmodified nigrosine dyes, fatty acid denatured nigrosine dyes, and carboxyl group-containing fatty acid denatured nigrosine dyes; commercially available products thereof include “BONTRON N-01”, “BONTRON N-04”, and “BONTRON N-07” (the above are manufactured by Orient Chemical Industries Co., Ltd.), “CHUO CCA-3” (manufactured by Chuo Synthetic Chemical Co., Ltd), and the like; triphenylmethane dyes having a tertiary amine as a branch; quaternary ammonium salt compounds, commercially available products thereof including “BONTRON P-51” (manufactured by Orient Chemical Industries, Co., Ltd.), and “TP-415” (manufactured by Hodogaya Chemical Co., Ltd.); cetyltrimethylammonium bromide, commercially available products thereof including “COPYCHARGEPXVP 435” (manufactured by Hoechst AG); amine compounds; amide compounds; imide compounds; metal soaps; metal complexes of oxycarboxylic acid; metal complexes of azo compounds; metal complex dyes; salicylic acid derivatives; and the like. One of these charge-controlling agents may be used alone or two or more types thereof may be used in combination.

As the charge-controlling agent, a positively chargeable charge-controlling agent is preferable, and from the viewpoint of the chargeability of the toner, at least one positively chargeable charge-controlling agent selected from the group consisting of a maleimide compound, a toluenesulfonamide compound, an octanoic acid metal soap, an octylic acid metal soap, and a naphthenic acid metal soap is more preferable.

As the maleimide compound, a polymer obtained by polymerizing a monomer having a maleimide skeleton is preferable, and examples thereof include a copolymer of an olefin monomer, an N-phenylmaleimide monomer, and a maleic acid monoamide monomer or a maleic acid monoester monomer, and the like.

Examples of the toluenesulfonamide compound include o-toluenesulfonamide, p-toluenesulfonamide, N-ethyl-p-toluenesulfonamide, N-butyl-p-toluenesulfonamide, and the like.

Examples of the octanoic acid metal soap, the octylic acid metal soap, and the naphthenic acid metal soap include metal salts of octanoic acid, octylic acid, and naphthenic acid. Examples of the metal forming the metal salt include manganese, calcium, zirconium, cobalt, iron, zinc, aluminum, copper, and the like.

From the viewpoint of the chargeability of the toner particles, the content of the charge-controlling agent is preferably from 0.01 parts by weight to 10 parts by weight with respect to 100 parts by weight of the toner particles, more preferably from 0.05 parts by weight to 5 parts by weight, even more preferably from 0.1 parts by weight to 2 parts by weight.

From the viewpoint of increasing electrostatic repulsion and preventing aggregation of toner particles by increasing the chargeability of the toner particles, a metal soap is preferable as the charge-controlling agent, and at least one metal soap selected from the group consisting of an octanoic acid metal soap, an octylic acid metal soap, and a naphthenic acid metal soap is preferable.

From the viewpoint, of preventing aggregation of the toner particles, the content of the metal soap is preferably from 0.01 parts by weight to 10 parts by weight with respect to 100 parts by weight of the toner particles, more preferably from. 0.05 parts by weight to 5 parts by weight or less, and even more preferably from 0.1 parts by weight to 2 parts by weight.

### —Other Additives—

The carrier liquid may also include a surfactant, a wetting agent, a thickener, an antisettling agent, a foaming agent, an antifoaming agent, an antioxidant, a softening agent, a filler, a perfuming agent, an anti-blocking agent, a release agent, and the like.

### [Method for Producing Liquid Developer]

The liquid developer according to the exemplary embodiment is prepared through, for example, a granulation process of preparing coarse toner particles and a wet pulverization process of pulverizing coarse toner particles in a carrier liquid.

The granulation process may be either a dry production method (for example, a kneading and pulverizing method) or a wet production method (for example, an aggregation coalescence method, a suspension polymerization method, a dissolution suspension method). These production methods are not particularly limited, and known production methods may be adopted. It is preferable to obtain coarse toner particles in a dry state by subjecting the coarse toner particles obtained by the wet production method to a washing process, a solid-liquid separation process, and a drying process. Coarse toner particles in a dry state and external additives may be mixed and an external additive may be attached to the surface of coarse toner particles.

In the wet pulverization process, after coarse toner particles are dispersed in a carrier liquid, for example, the coarse toner particles are wet-pulverized in a carrier liquid using a media, type wet pulverizer such as a bead mill, a ball mill, a sand mill, or an attritor. For example, the dispersant or charge-controlling agent is added in advance to the carrier liquid, the coarse toner particles are dispersed in a carrier liquid including a dispersant or a charge-controlling agent, and wet pulverization is carried out. Alternatively, after coarse toner particles are wet-pulverized in a carrier liquid, a dispersant or charge-controlling agent is added to the carrier liquid.

In addition, the liquid developer according to the exemplary embodiment is prepared, for example, by preparing toner particles in a solvent by a wet production method and replacing the solvent, with a carrier liquid as necessary. In this production method, the wet production method may be any of an aggregation coalescence method, a suspension polymerization method, a dissolution suspension method, or the like, and a known production method may be adopted. As a solvent to be used in the wet production method, the same solvent as the carrier liquid, a solvent which is able to replace the carrier liquid (for example, a solvent having a lower boiling point, than the carrier liquid), or a mixed solvent thereof is preferable. In this production method, for example, after preparing toner particles in a carrier liquid by a wet production method, a dispersant or a charge-controlling agent is added to a carrier liquid; or a carrier liquid including a dispersant or a charge-controlling agent, is replaced with a solvent used in the wet production method.

The content ratio of the carrier liquid and the toner particles in the liquid developer according to the exemplary embodiment is, for example, from 5 parts by weight to 35 parts by weight of toner particles with respect to 100 parts by weight of the carrier liquid.

### <Liquid Developer Cartridge>

The liquid developer cartridge according to the exemplary embodiment contains the liquid developer according to the exemplary embodiment and is detachable from the image forming apparatus. The liquid developer cartridge may have a container that contains the liquid developer. The liquid developer contained, in the liquid developer cartridge according to the exemplary embodiment, for example, is supplied to the developing unit of the image forming apparatus through a supply pipe provided in the image forming apparatus. The form of the liquid developer cartridge according to the exemplary embodiment is not limited, and examples thereof include a tank shape and a bottle shape. The capacity of the liquid developer cartridge according to the exemplary embodiment may be selected according to the size of the image forming apparatus.

### <Image Forming Apparatus and Image Forming Method>

An image forming apparatus according to the exemplary embodiment is provided with an image holding member, a charging unit which charges a surface of the image holding member, an electrostatic charge image forming units which forms an electrostatic charge image on the surface of the charged image holding member, a developing unit which contains the liquid developer and develops the electrostatic charge image formed on the surface of the image holding member as a toner image using the liquid developer, a transfer unit which transfers the toner image formed on the surface of the image holding member to the surface of the recording medium, and a fixing unit which fixes the toner image transferred on the surface of the recording medium. In the image forming apparatus according to the exemplary embodiment, the liquid developer according to the exemplary embodiment is used as the liquid developer.

The image forming apparatus according to the exemplary embodiment carries out an image forming method (the image forming method according to the exemplary embodiment) which has a charging unit of charging the surface of the image holding member, an electrostatic charge image forming unit of forming an electrostatic charge image on the surface of the charged image holding member, a developing unit of developing the electrostatic charge image formed on the surface of the image holding member as a toner image using the liquid developer, a transfer unit of transferring the toner image formed on the surface of the image holding member onto the surface of the recording medium, a fixing unit of fixing the transferred toner image on the surface of a recording medium.

The image forming apparatus according to the exemplary embodiment, includes, for example, a direct transfer type apparatus which directly transfers a toner image formed on the surface of the image holding member onto a recording medium; an intermediate transfer type apparatus which primarily transfers a toner image formed on the surface of the image holding member onto the surface of an intermediate transfer member and secondarily transfers the toner image transferred to the surface of the intermediate transfer member onto the surface of the recording medium; an apparatus provided with an erasing unit for erasing the surface of the image holding member before charging after transferring the toner image; an apparatus provided with an erasing unit for irradiating the surface of the image holding member with an erasing light after-transferring the toner image and before charging; and the like. In the case where the image forming apparatus according to the exemplary embodiment is an intermediate transfer type apparatus, the transfer unit has, for example, an intermediate transfer member to which a toner image is transferred on the surface, a primary transfer unit which primarily transfers the toner image formed on the surface of the image holding member onto the surface of the intermediate transfer member, and a secondary transfer unit which secondarily transfers the toner image transferred to the surface of the intermediate transfer member to the surface of the recording medium.

In the image forming apparatus (image forming method) according to the exemplary embodiment, it is preferable that the fixing device (fixing unit) perform fixing in two stages. Specifically, the fixing device (fixing unit) preferably is a non-contact heating device (non-contact type heating unit) which heats the toner image in a non-contact manner, and a heating and pressing device (heating and pressing unit) for applying pressure while heating after the heating by the non-contact heating device (after the non-contact heating unit).

The recording medium is not particularly limited, and a known recording medium is used. Examples thereof include a thermoplastic resin film, paper, an OHP sheet, and the like. Application of the thermoplastic resin film include labels, packaging materials, posters, and the like.

Examples of the thermoplastic resin film include polyolefin films such as polyethylene and polypropylene; polyester films such as polyethylene terephthalate and polybutylene terephthalate; polyamide films such as nylon; films such as polycarbonate, polystyrene, modified polystyrene, polyvinyl chloride, polyvinyl alcohol, and polylactic acid; and the like. These films may be either unstretched films, or uniaxially or biaxially stretched films. The thermoplastic resin film may be in the form of a single layer or a multilayer. The thermoplastic resin film may be a film having a surface coat layer for assisting the toner fixing, a film subjected to a corona treatment, an ozone treatment, a plasma treatment, a flame treatment, a glow discharge treatment, or the like. The thickness of the thermoplastic resin film for use in a soft packaging material is, for example, from 5 μm to 250 μm, and preferably from 10 μm to 100 μm.

In the following, a description will be given of an image forming apparatus according to the exemplary embodiment with reference to the drawing,

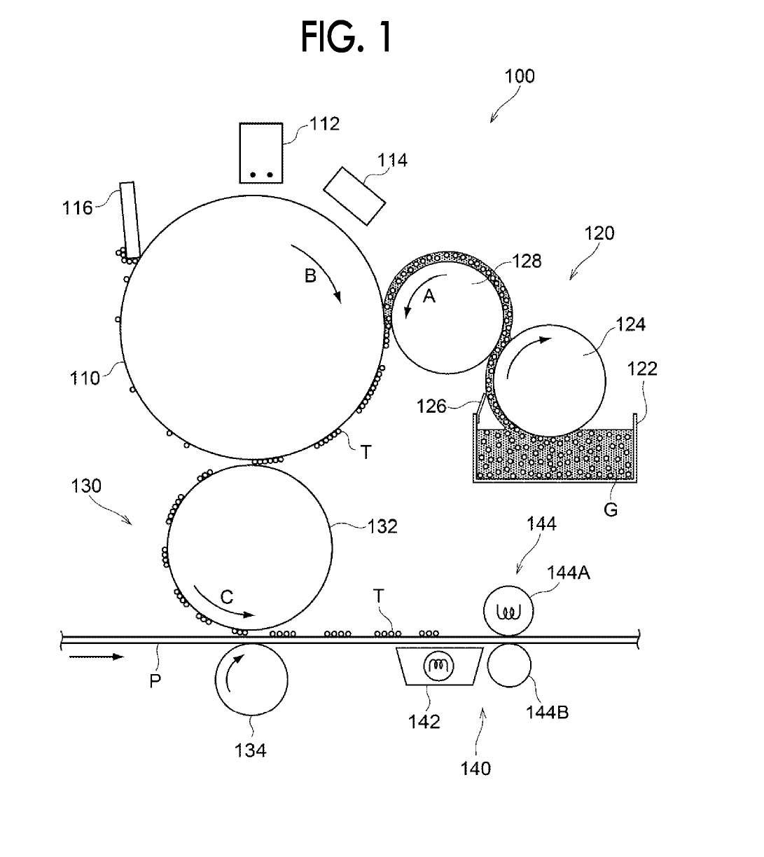

FIG. 1 is a schematic configuration diagram of an example of an image forming apparatus according to the exemplary embodiment.

An image forming apparatus 100 shown in FIG. 1 is provided with a photoreceptor 110 (an example of an image holding member), a charging device 112 (an example of a charging unit), an exposure device 114 (an example of an electrostatic charge image forming unit), a developing device 120 (an example of a developing unit), a transfer device 130 (an example of a transfer unit), a fixing device 140 (an example of a fixing unit), and a cleaner 116.

The photoreceptor 110 has a cylindrical shape and the charging device 112, the exposure device 114, the developing device 120, the transfer device 130, and the cleaner 116 are provided in order around the photoreceptor 110.

The charging device 112 charges the surface of the photoreceptor 110.

The exposure device 114 forms an electrostatic charge image by exposing the charged surface of the photoreceptor 110 using a laser beam, for example, based on the image signal.

The developing device 120 is provided with a developer accommodating container 122, a developer supply roller (anilox roller) 124, a regulating member 12 6, and a developing roller 128.

The developer accommodating container 122 contains the liquid developer G. An agitation member (not shown) for agitating the liquid developer G may be provided in the developer accommodating container 122.

The developer supply roller 124 is provided so that a part thereof is immersed in the liquid developer G contained in the developer accommodating container 122 and is brought close (or in contact with) the developing roller 128, and the liquid developer G in the developer accommodating container 122 is supplied to the surface of the developing roller 128. The regulating member 126 controls the supply amount of the liquid developer G by the developer supply roller 124.

The developing roller 128 holds the liquid developer G supplied from the developer supply roller 124 and develops the electrostatic charge image formed on the surface of the photoreceptor 110 as a toner image T using the liquid developer G.

The transfer device 130 is an intermediate transfer-type device provided with a drum-shaped intermediate transfer member 132 to which the toner image T formed on the surface of the photoreceptor 110 is transferred and a transfer roller 134 which transfers the toner image T transferred on the surface of the intermediate transfer member 132 to the recording medium P.

The transfer device 130 may have a configuration provided with a belt-shaped intermediate transfer member 132, or may have a direct transfer type configuration which transfers the toner image T to the recording medium P directly from the photoreceptor 110 using the transfer roller 134 without being provided with the intermediate transfer member 132.

The fixing device 140 is presided on the downstream side of the transfer device 130 in the traveling direction of the recording medium P, and is provided with a non-contact heating device 142 and a heating and pressing device 144.

The non-contact heating device 142 is, for example, a plate-shaped heating device provided with a heat source inside a metal housing. The non-contact heating device 142 may be provided with a blowing device together with a heat source inside the housing. The non-contact heating device 142 may be provided on the side of the recording medium on which the toner image is formed, may be provided on the back side (the side on which the toner image is not formed) of the recording medium, or may be provided on both sides.

The heating and pressing device 144 is, for example, a pair of a heating roller 144A and a pressing roller 144B. The heating roller 144A and the pressing roller 144B are arranged to be opposed to each other so as to nip the recording medium therebetween. A heat source is provided inside the heating roller 144A. In addition, the heating and pressing device 144 may be a device combining a heating and pressing roller and a pressing belt, a device combining a pressing roller and a heating and pressing belt, or the like.

The cleaner 116 is provided for the purpose of removing and collecting the transfer residual toner remaining on the surface of the photoreceptor 110 after the transfer of the toner image.

The image forming apparatus 100 may be further provided with an erasing device (not shown) for erasing the charge on the surface of the photoreceptor 110 after the transfer and before the next charging.

A description will be given below of an image forming method by the image forming apparatus 100.

The charging device 112, the exposure device 114, the developing device 120, the transfer device 130, the fixing device 140, and the cleaner 116 are operated in synchronization with the rotation speed of the photoreceptor 110.

First, the charging device 112 charges the surface of the photoreceptor 110 rotating in the direction of arrow B to a potential predetermined in advance.

Next, the exposure device 114 exposes the charged surface of the photoreceptor 110 based on an image signal to form an electrostatic charge image.

In the developing device 120, the developer supply roller 124 supplies the liquid developer G to the surface of the developing roller 128, and the developing roller 128 rotating in the direction of arrow A transports the liquid developer G to the photoreceptor 110.

The liquid developer G is supplied to the electrostatic charge image on the photoreceptor 110 at a position where the developing roller 128 and the photoreceptor 110 are brought close to (or in contact with) each other, and develops (visualizes) the electrostatic charge image to form a toner image T.

Next, the toner image T on the surface of the photoreceptor 110 is transferred onto the surface of the intermediate transfer member 132 rotating in the direction of arrow C.

Next, the toner image T transferred to the surface of the intermediate transfer member 132 is transferred to the recording medium P at the contact position with the transfer roller 134. This transfer is carried out by nipping the recording medium P between the transfer roller 134 and the intermediate transfer member 132 and bringing the toner image T on the surface of the intermediate transfer member 132 into close contact with the recording medium P.

The recording medium P to which the toner image T is transferred is transported to the fixing device 140 and passes through the non-contact heating device 142 and the heating and pressing device 144 in this order to form a fixed image on the surface of the recording medium P.

In a case where paper is used as the recording medium P, the heating temperature of the non-contact heating device 142 is preferably from 100° C. to 160° C., and more preferably from 110° C. to 150° C. In a case where a thermoplastic resin film is used as the recording medium P, the heating temperature of the non-contact heating device 142 is preferably from 70° C. to 110° C., and more preferably from 80° C. to 100° C. The heating time is determined by the processing speed of the non-contact heating device 142.

The toner image heated by the non-contact heating device 142 is further heated and pressed by the heating and pressing device 144 (the heating roller 144A and the pressing roller 144B), to fix the toner image on the recording medium P.

In a case where paper is used as the recording medium. P, the heating temperature of the heating and pressing device 144 is preferably from 100° C. to 160° C., and more preferably from 110° C. to 150° C. In a case where a thermoplastic resin film is used as the recording medium P, the heating temperature of the heating and pressing device 144 is preferably from 70° C. to 110° C., and more preferably from 80° C. to 100° C. The pressure applied by the heating and pressing device 144 is preferably from 1.5 kg/cm² to 5 kg/cm², more preferably from 2 kg/cm² to 3.5 kg/cm².

After the toner image T is transferred to the intermediate transfer member 132, the transferred residual toner is removed and collected from the photoreceptor 110 by the cleaner 116, and the process returns to the charging unit again.

The image forming apparatus 100 may be a tandem type full color image forming apparatus, in which the photoreceptor 110, the charging device 112, the exposure device 114, the developing device 120, the transfer device 130, and the cleaner 116 are one unit, and four of these units are lined up and mounted therein.

The image forming apparatus 100 may be of a type in which toner particles or externally added toner is supplied from a toner cartridge (not shown) to the developer accommodating container 122, or of a type in which a liquid developer is supplied from a liquid, developer cartridge (not shown). The toner cartridge or the liquid developer cartridge may have a configuration detachable from the image forming apparatus so as to be detachable when the remaining amount of the liquid, developer runs out.

### EXAMPLES

A detailed description will be given below of exemplary embodiments of the present invention using examples, but exemplary embodiments of the invention are not limited to these examples.

### Example 1

50 parts by mol of terephthalic acid, 45 parts by mol of bisphenol A propylene oxide 2 mol adduct, 5 parts by mol of ethylene glycol, and dibutyltin oxide as a catalyst are placed in a heated and dried two-necked flask, and air in the container is set to an inert atmosphere by a depressurizing operation with nitrogen gas and agitated by mechanical agitation at 180 rpm for 5 hours. Thereafter, the temperature is slowly raised to 230° C. under reduced pressure, and the mixture is agitated for 2 hours, and when the mixture entered a viscous state, the mixture is air-cooled to stop the reaction, thereby obtaining a polyester resin (1). As a result of molecular weight measurement, by GPC (in terms of polystyrene) of the weight average molecular weight (Mw) of the polyester resin (1) is 20,000.

85 parts by weight of the polyester resin (1) and 15 parts by weight of C.I. Pigment Red 238 (azo pigment) are mixed in a HENSCHEL MIXER. Next, the mixture is kneaded using a BANBURY MIXER, and the cooled product is coarsely pulverized into 2 mm or less square.

20 parts by weight of coarse pulverized particles and 80 parts by weight, of isoparaffin (trade name: ISOPAR L, Exxon Mobil Corporation) are mixed and pulverized for 168 hours using a ball mill and zirconia beads having a diameter of 5 mm to prepare a toner particle dispersion. When the particle diameter is measured with a laser diffraction/scattering particle diameter distribution measuring apparatus (LA-960 manufactured by Horiba, Ltd.), the volume average particle diameter is 1.6 μm.

5 parts by weight of SOLSPERSE 13940 (reaction product of polyethyleneimine and a 12-hydroxystearic acid self-condensation product, Lubrizol Corporation) and 0.5 parts by weight of zirconium octancate are added to 100 parts by weight of the toner particle dispersion, then agitated and mixed to prepare a liquid developer.

### Examples 2 to 23

The respective liquid developers are prepared in the same manner as in Example 1 except that the composition of the polyester resin (copolymerization ratio of the monomers) is changed as shown in Table 1.

### Comparative Examples 1 to 14

The respective liquid developers are prepared in the same manner as in Example 1 except that the composition of the polyester resin (copolymerization ratio of the monomers) is changed as shown in Table 1.

### Example 24

A liquid developer is prepared in the same manner as in Example 1 except that the composition of the polyester resin (the copolymerization ratio of the monomers) is changed as shown in Table 1, and SOLSPERSE 13940 is changed to 5 parts by weight of AJISPER PB 821 (reaction product of polyallylamine and polycaprolactone, Ajinomoto Fine Techno Co., Inc.).

### Example 25

A liquid developer is prepared in the same manner as in Example 1 except that, the composition of the polyester resin (the copolymerization ratio of the monomers) is changed as shown in Table 1 and zirconium, octanoate is changed to 0.5 parts by weight of zirconium octylate.

### Example 26

A liquid developer is prepared in the same manner as in Example 1 except that the composition of the polyester resin (the copolymerization ratio of the monomers) is changed as shown in Table 1 and zirconium octanoate is changed to 0.5 parts by weight of zirconium naphthenate.

### <Evaluation of Image Granularity>

Patch images having a size of 20 mm*20 mm and a density which is varied in increment of 10% in a range of from 10% to 100% each is formed on a plain paper, ana with respect to the patch image having an image density nearest to 0.3, 10 patch images are visually evaluated in terms of the rough feeling. The results are shown in Table 1. The image density is measured by X-Rite spectrophotometer 962 (manufactured by X-Rite).
G1: It is not possible to confirm any rough feeling for any patch image.
G2: A rough feeling is recognized in 1 to 2 patch images.
G3: A rough feeling is recognized in 3 to 4 patch images.
G4: There is a rough feeling on 5 or more patch images.

TABLE 1

| | Monomer of Polyester Resin [mol % with respect to all monomers] | | | | | | | | | | | | | | |
|---|---|---|---|---|---|---|---|---|---|---|---|---|---|---|---|
| | | | | | | | Aromatic | | | | | Amount of | | | |
| | Aromatic | Aliphatic dicarboxylic acid | | | | | diol | Aliphatic diol | | | | aliphatic | | | |
| | dicarbonate | Succinic | Adipic | Pimelic | Suberic | Malonic | Bisphenol A | Ethylene | Propylene | 1,5-pentane | 1,6- | monomer with | Additive | | |
| | Terephthalic | acid | acid | acid | acid | acid | propylene | glycol | glycol | diol | hexanediol | C2 to C5 carbon | | Charge- | Graininess |
| | acid | C2 | C4 | C5 | C6 | C1 | oxide adduct | C2 | C3 | C5 | C6 | atoms [mol %] | Dispersant | controlling agent | of image |
| Example 1 | 50 | — | — | — | — | — | 45 | 5 | — | — | — | 5 | SOLSPERSE 13940 | Octanoic acid Zr | G2 |
| Example 2 | 50 | — | — | — | — | — | 45 | — | 5 | — | — | 5 | SOLSPERSE 13940 | Octanoic acid Zr | G2 |
| Example 3 | 50 | — | — | — | — | — | 45 | — | — | 5 | — | 5 | SOLSPERSE 13940 | Octanoic acid Zr | G2 |
| Comparative | 50 | — | — | — | — | — | 45 | — | — | — | 5 | 0 | SOLSPERSE 13940 | Octanoic acid Zr | G4 |
| Example 1 | | | | | | | | | | | | | | | |
| Example 4 | 50 | — | — | — | — | — | 35 | 15 | — | — | — | 15 | SOLSPERSE 13940 | Octanoic acid Zr | G1 |
| Example 5 | 50 | — | — | — | — | — | 35 | — | 15 | — | — | 15 | SOLSPERSE 13940 | Octanoic acid Zr | G1 |
| Example 6 | 50 | — | — | — | — | — | 35 | — | — | 15 | — | 15 | SOLSPERSE 13940 | Octanoic acid Zr | G2 |
| Comparative | 50 | — | — | — | — | — | 35 | — | — | — | 15 | 0 | SOLSPERSE 13940 | Octanoic acid Zr | G3 |
| Example 2 | | | | | | | | | | | | | | | |
| Example 7 | 50 | — | — | — | — | — | 25 | 25 | — | — | — | 25 | SOLSPERSE 13940 | Octanoic acid Zr | G2 |
| Example 8 | 50 | — | — | — | — | — | 25 | — | 25 | — | — | 25 | SOLSPERSE 13940 | Octanoic acid Zr | G2 |
| Example 9 | 50 | — | — | — | — | — | 25 | — | — | 25 | — | 25 | SOLSPERSE 13940 | Octanoic acid Zr | G1 |
| Comparative | 50 | — | — | — | — | — | 25 | — | — | — | 25 | 0 | SOLSPERSE 13940 | Octanoic acid Zr | G3 |
| Example 3 | | | | | | | | | | | | | | | |
| Example 10 | 45 | 5 | — | — | — | — | 50 | — | — | — | — | 5 | SOLSPERSE 13940 | Octanoic acid Zr | G2 |
| Example 11 | 45 | — | 5 | — | — | — | 50 | — | — | — | — | 5 | SOLSPERSE 13940 | Octanoic acid Zr | G2 |
| Example 12 | 45 | — | — | 5 | — | — | 50 | — | — | — | — | 5 | SOLSPERSE 13940 | Octanoic acid Zr | G2 |
| Comparative | 45 | — | — | — | 5 | — | 50 | — | — | — | — | 0 | SOLSPERSE 13940 | Octanoic acid Zr | G4 |
| Example 4 | | | | | | | | | | | | | | | |
| Comparative | 45 | — | — | — | — | 5 | 50 | — | — | — | — | 0 | SOLSPERSE 13940 | Octanoic acid Zr | G3 |
| Example 5 | | | | | | | | | | | | | | | |
| Example 13 | 35 | 15 | — | — | — | — | 50 | — | — | — | — | 15 | SOLSPERSE 13940 | Octanoic acid Zr | G1 |
| Example 14 | 35 | — | 15 | — | — | — | 50 | — | — | — | — | 15 | SOLSPERSE 13940 | Octanoic acid Zr | G1 |
| Example 15 | 35 | — | — | 15 | — | — | 50 | — | — | — | — | 15 | SOLSPERSE 13940 | Octanoic acid Zr | G2 |
| Comparative | 35 | — | — | — | 15 | — | 50 | — | — | — | — | 0 | SOLSPERSE 13940 | Octanoic acid Zr | G3 |
| Example 6 | | | | | | | | | | | | | | | |
| Comparative | 35 | — | — | — | — | 15 | 50 | — | — | — | — | 0 | SOLSPERSE 13940 | Octanoic acid Zr | G3 |
| Example 7 | | | | | | | | | | | | | | | |
| Example 16 | 25 | 25 | — | — | — | — | 50 | — | — | — | — | 25 | SOLSPERSE 13940 | Octanoic acid Zr | G2 |
| Example 17 | 25 | — | 25 | — | — | — | 50 | — | — | — | — | 25 | SOLSPERSE 13940 | Octanoic acid Zr | G2 |
| Example 18 | 25 | — | — | 25 | — | — | 50 | — | — | — | — | 25 | SOLSPERSE 13940 | Octanoic acid Zr | G1 |
| Comparative | 25 | — | — | — | 25 | — | 50 | — | — | — | — | 0 | SOLSPERSE 13940 | Octanoic acid Zr | G3 |
| Example 8 | | | | | | | | | | | | | | | |
| Comparative | 25 | — | — | — | — | 25 | 50 | — | — | — | — | 0 | SOLSPERSE 13940 | Octanoic acid Zr | G4 |
| Example 9 | | | | | | | | | | | | | | | |
| Example 19 | 45 | 5 | — | — | — | — | 45 | 5 | — | — | — | 10 | SOLSPERSE 13940 | Octanoic acid Zr | G2 |
| Example 20 | 40 | 5 | — | — | 5 | — | 40 | 5 | — | — | 5 | 10 | SOLSPERSE 13940 | Octanoic acid Zr | G2 |
| Example 21 | 45 | 5 | — | — | — | — | 40 | 10 | — | — | — | 15 | SOLSPERSE 13940 | Octanoic acid Zr | G1 |
| Example 22 | 40 | 10 | — | — | — | — | 35 | 15 | — | — | — | 25 | SOLSPERSE 13940 | Octanoic acid Zr | G2 |
| Comparative | 48 | 2 | — | — | — | — | 48 | 2 | — | — | — | 4 | SOLSPERSE 13940 | Octanoic acid Zr | G3 |
| Example 10 | | | | | | | | | | | | | | | |
| Comparative | 35 | 15 | — | — | — | — | 35 | 15 | — | — | — | 30 | SOLSPERSE 13940 | Octanoic acid Zr | G3 |
| Example 11 | | | | | | | | | | | | | | | |
| Comparative | 30 | 20 | — | — | — | — | 30 | 20 | — | — | — | 40 | SOLSPERSE 13940 | Octanoic acid Zr | G4 |
| Example 12 | | | | | | | | | | | | | | | |
| Example 23 | 40 | — | 10 | — | — | — | 35 | — | 15 | — | — | 25 | SOLSPERSE 13940 | Octanoic acid Zr | G2 |
| Comparative | 40 | — | — | — | 10 | — | 35 | — | — | — | 15 | 0 | SOLSPERSE 13940 | Octanoic acid Zr | G3 |
| Example 13 | | | | | | | | | | | | | | | |
| Comparative | 40 | — | — | — | — | 10 | 35 | — | — | — | 15 | 0 | SOLSPERSE 13940 | Octanoic acid Zr | G3 |
| Example 14 | | | | | | | | | | | | | | | |
| Example 24 | 45 | 5 | — | — | — | — | 40 | 10 | — | — | — | 15 | AJISPER PB 821 | Octanoic acid Zr | G1 |
| Example 25 | 45 | 5 | — | — | — | — | 40 | 10 | — | — | — | 15 | SOLSPERSE 13940 | Octanoic acid Zr | G1 |
| Example 26 | 45 | 5 | — | — | — | — | 40 | 10 | — | — | — | 15 | SOLSPERSE 13940 | Naphthenic acid Zr | G1 |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A liquid developer comprising:
toner particles containing, as a binder resin, at least a polyester resin containing a monomer unit which includes a linear or branched chain saturated hydrocarbon chain having 2 to 5 carbon atoms between ester bonds, in a range of from 5 mol % to 25 mol % with respect to all monomer units of the polyester resin, and a colorant; and
a carrier liquid including an insulating liquid.

2. The liquid developer according to claim 1,
wherein the polyester resin contains a monomer unit having an aromatic ring in a range of from 50 mol % to 95 mol % with respect to all the monomer units.

3. The liquid developer according to claim 2,
wherein the monomer unit having an aromatic ring has from 1 to 4 aromatic rings.

4. The liquid developer according to claim 1,
wherein the polyester resin has a weight average molecular weight of 5,000 to 1,000,000.

5. The liquid developer according to claim 1,
wherein a ratio of a content of the polyester resin to a total content of the binder resin included in the toner particle is 50% by weight or more.

6. The liquid developer according to claim 5,
wherein a content of the binder resin is from 40% by weight to 95% by weight with respect to a total amount of the toner particle.

7. The liquid developer according to claim 1,
wherein the colorant contains an azo pigment.

8. The liquid developer according to claim 1,
wherein a content of the colorant is from 1% by weight to 30% by weight, with respect to a total amount, of the toner particle.

9. The liquid developer according to claim 1,
wherein the carrier liquid has an electrical conductivity of 1×10⁻¹⁰ S/m or less.

10. The liquid developer according to claim 1,
wherein the carrier liquid has a flash point of 130° C. or less.

11. The liquid developer according to claim 1,
wherein the carrier liquid includes a volatile oil as the insulating liquid.

12. The liquid developer according to claim 1,
wherein the carrier liquid includes a mineral oil as the insulating liquid.

13. The liquid developer according to claim 12,
wherein a ratio of a content of the mineral oil to a total amount of the insulating liquid is 50% by weight or more.

14. The liquid developer according to claim 1,
wherein the carrier liquid further includes at least one positively chargeable charge-controlling agent selected from the group consisting of a maleimide compound, a toluenesulforiamide compound, an octanoic acid metal soap, an octylic acid metal soap, and a naphthenic acid metal soap.

15. The liquid developer according to claim 1,
wherein the carrier liquid further includes at least one metal soap selected from the group consisting of an octanoic acid metal soap, an octylic acid metal soap, and a naphthenic acid metal soap.

16. The liquid developer according to claim 1,
wherein the carrier liquid further includes a polymer dispersant,

17. The liquid developer according to claim 16,
wherein the polymer dispersant is a polymer amine.

18. The liquid developer according to claim 17,
wherein the carrier liquid further includes a compound having at least one of a polyethyleneimine chain and a polyallylamine chain in a molecule.

19. The liquid developer according to claim 17, wherein the polymer dispersant has a weight average molecular weight of 100 to 1,000,000.

20. A liquid developer cartridge comprising:
a container that contains the liquid developer according to claim 1, wherein the liquid developer cartridge is detachable from an image forming apparatus
